(19) United States
(12) Patent Application Publication
(10) Pub. No.: US 2005/0162586 A1
(43) Pub. Date: Jul. 28, 2005

(54) Liquid crystal display panel and a method for manufacture thereof

(75) Inventor: Byungseong Bae, Suwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: ILJIN DIAMOND CO., LTD., Umsung-gun (KR)

(21) Appl. No.: 10/512,883

(22) PCT Filed: Jul. 25, 2003
(86) PCT No.: PCT/KR03/01493

(51) Int. Cl. G02F 1/1335

(52) U.S. Cl. 349/95

(57) ABSTRACT

The present invention is related to liquid crystal display panel and making process thereof, more specifically, liquid crystal display is comprised micro lens array. In liquid crystal display panel is displaying an image to cut off light or pass light in light through area which liquid crystal is forming between upper transparent plate and lower transparent plate and distributing wire part is formed pixel area on lower transparent plate is comprising, Plural lens shape groove is systematically arranged on lower transparent plate which opposite upper transparent plate; and Having critical thickness insulating layer what is on plural lens shape groove and lower transparent plate, micro lens is formed on lower transparent plate and TFT is formed on transparent insulating layer.

### TECHNICAL FIELD

The present invention generally relates to a thin film transistor liquid crystal display panel to which a micro lens array is attached and a making process thereof, and more specifically, to a thin film transistor liquid crystal display panel and a making process thereof for easily arranging the micro lens array by forming the micro lens array concentrating light on pixels in a lower substrate of a liquid crystal display.

### BACKGROUND ART

A liquid crystal display transmits or cuts off light on pixels by using optical anisotropy. Such liquid crystal display consists of many pixels, and in case of an XGA level, the liquid crystal display has the number of pixels having 1024×768 of columns and rows. Each pixel is connected to thin film transistors, switching elements. Wires to which data signals and scanning signals for displaying images are inputted are vertically crossed each other in the pixels. The thin film transistors are located on cross points of the wires, and apply or cut off electric fields to liquid crystals by switching operations of the thin film transistors, thereby cutting off or transmitting light.

The liquid crystal display panel is divided into light cut-off regions and light transmission regions. The light cut-off regions form the thin film transistors, the switching elements for switching the liquid crystals, and cut off incident light. The light transmission regions are defined as the rest regions except the light cut-off regions. The light transmission regions are commonly called pixel regions.

A ratio of the light cut-off regions and the light transmission regions of the liquid crystal display is called an opening ratio. If the liquid crystal display has a high opening ratio, it can obtain more improved brightness with the same power.

Thus, in order to increase the opening ratio, a micro lens array is generally attached to an upper substrate of the liquid crystal display so that much light passes through the liquid crystal display. Irradiated light is refracted by micro lenses, and passes through the light transmission regions out of from the light cut-off regions. Therefore, if the micro lenses are used, a large amount of light passes through the pixels, thereby substantially increasing the opening ratio.

However, the thin film transistor liquid crystal display to which the micro lens array is attached in accordance with prior art has small sizes of the micro lenses as well as each pixel of the liquid crystal display. As a result, it needs a very precise operation when exactly attaching the micro lens array to the upper substrate.

In addition, there is a very high possibility of damaging the micro lens array while attaching the micro lens array to the upper substrate.

Because of the above problems, it takes a lot of time and cost while attaching the micro lens array to the thin film transistor liquid crystal display.

### DISCLOSURE OF INVENTION

It is therefore an object of the present invention to provide a thin film transistor liquid crystal display panel and a making process thereof to make the liquid crystal display brighter by concentrating light on light transmission regions and increasing a substantial opening ratio of the liquid crystal display after forming a micro lens array to a lower substrate.

To accomplish the above object, in a thin film transistor liquid crystal display panel injecting liquid crystals between a transparent upper substrate and a transparent lower substrate, and forming a light cut-off unit having many thin film transistors for turning on/off the liquid crystals on a surface of the lower substrate opposite to the upper substrate, the present invention, comprising: many lens grooves regularly arranged on the surface of the lower substrate opposite to the upper substrate, having predetermined radiuses, and formed by etching; and a transparent insulating film having predetermined thickness disposed on the lens grooves and the lower substrate. Many micro lenses formed by the lens grooves and the transparent insulating film are formed on the lower substrate. The thin film transistors are formed in an upper part of the transparent insulating film.

Also, to accomplish the above object, in a method of making a thin film transistor liquid crystal display panel injecting liquid crystals between a transparent upper substrate and a transparent lower substrate, and forming a light cut-off unit having many thin film transistors for turning on/off the liquid crystals on a surface of the lower substrate opposite to the upper substrate, the present invention, comprising the steps of: a first step of forming photo registers on a transparent substrate by depositing and patterning the photo registers on the transparent substrate; a second step of etching the transparent substrate to create certain size of lens grooves on the transparent substrate; and a third step of forming the lower substrate by depositing a transparent insulating film in an upper part of the etched transparent substrate and planarizing an upper part of the transparent insulating film.

### BRIEF DESCRIPTION OF DRAWINGS

FIG. 1 is a diagram illustrating a making process of a thin film transistor liquid crystal display panel in accordance with the present invention.

FIG. 2 through FIG. 4 are diagrams illustrating making processes of a lower substrate of a thin film transistor liquid crystal display panel in accordance with the present invention.

FIG. 5 is a diagram illustrating one embodiment of a thin film transistor liquid crystal display panel created according to the present invention.

### BEST MODE FOR CARRING OUT THE INVENTION

The present invention will be described in detail through preferred embodiments with reference to accompanying drawings, compared to prior art.

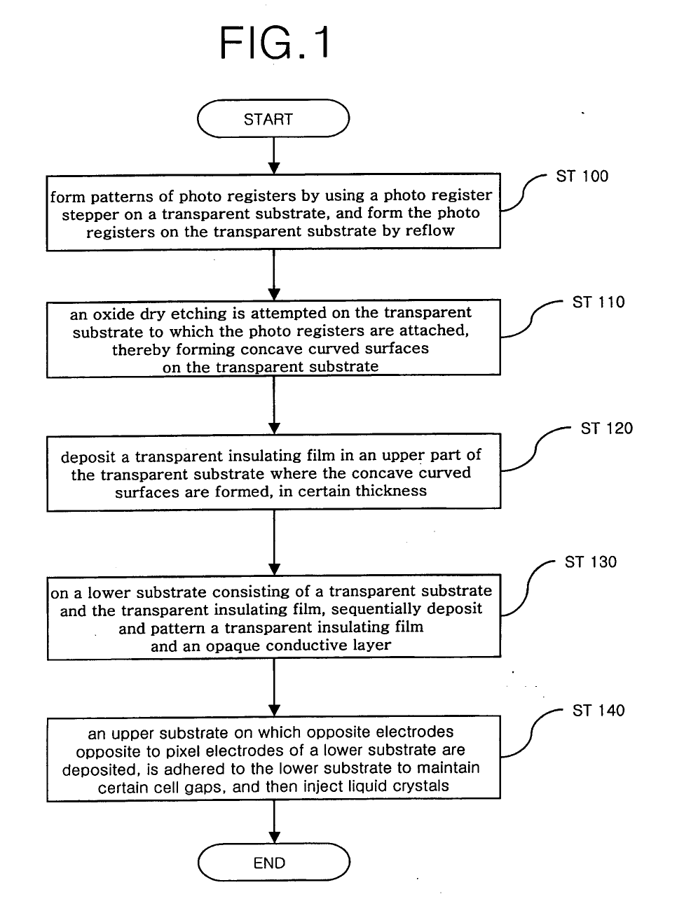

FIG. 1 is a diagram illustrating one embodiment of a making process of a thin film transistor liquid crystal display panel in accordance with the present invention. The liquid crystal display panel in accordance with the present invention will be described by using FIG. 1 through FIG. 5.

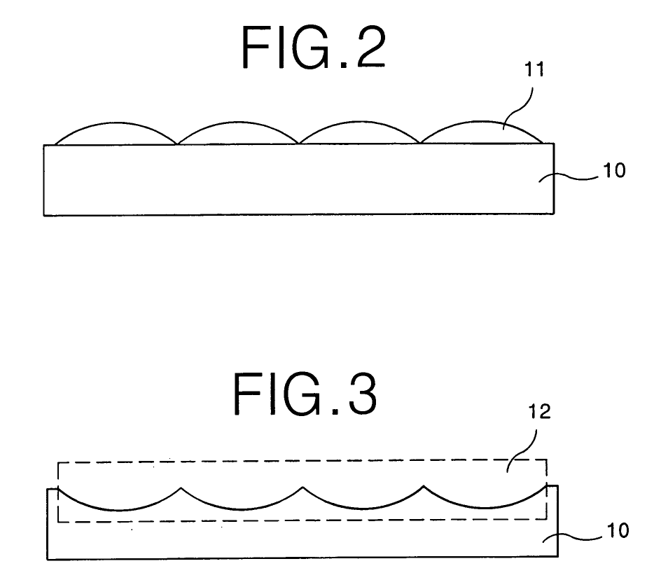

A first step (ST 100): form patterns of photo registers (11) by using a photo register stepper on a transparent substrate (10), and form the photo registers (11) on the transparent substrate by reflow like shown in FIG. 2. Since the photo registers (1) are contracted while performing a subsequent process, form the photo registers (11) bigger than micro lenses in size, while designing a mask for forming the patterns of the photo registers (11). Then, it is desirable to use a quartz substrate as the transparent substrate (10) for a high-temperature poly thin film transistor liquid crystal display.

A second step (ST 110): if an oxide dry etching is attempted on the transparent substrate (10) to which the photo registers (11) are attached, the photo registers (11) and an oxide are simultaneously etched, thereby forming concave curved surfaces (12) on the transparent substrate (10) like shown in FIG. 3.

A third step (ST 120): deposit a transparent insulating film (13) in an upper part of the transparent substrate (11) where the concave curved surfaces (12) are formed, in certain thickness. The thickness of the transparent insulating film (13) is determined by a radius of the curved surfaces (12) formed on the transparent substrate (10). If a focal distance is long, deposit the transparent insulating film (130) in thick way, and if the focal distance is short, deposit the transparent insulating film (13) in thin way.

First, deposit one transparent insulating film layer to fill the concave curved surfaces (12) with the transparent insulating film (13), and planarize an upper part of the transparent insulating film, then cover the transparent insulating film, thereby forming a micro lens array. If the thick transparent insulating film (13) is used according to a focal distance of the micro lenses, the transparent insulating film (13) is deposited in many layers.

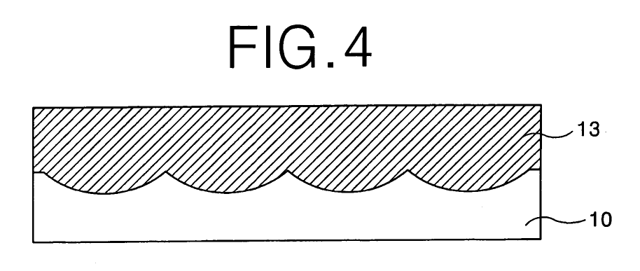

The transparent insulating film (13) is deposited in the upper part of the transparent substrate (10), thus a lower substrate where a micro lens array is formed is formed like shown in FIG. 4.

For a method of depositing the transparent insulating film (13) in a location where the micro lens array is formed, a chemical vapor deposition method is generally used. However, the chemical vapor deposition method has a slow deposition speed. Thus, it is desirable to deposit insulating films having tens of micro thickness by using an FHD(Flame Hydrolysis Deposition) method. The FHD method can obtain a faster deposition speed than that of the chemical vapor deposition method.

Furthermore, it is possible to change a refractive index of the transparent insulating films by adding additives such as TiO2, GeO2, and P2O5 to SiO2 oxide. Thus, light to be irradiated to light cut-off regions can be refracted at a bigger angle by increasing a refractive index of the micro lenses, thereby irradiating much light to the light cut-off regions.

Supposing a refractive index of pure SiO2 oxide is n0 and a refractive index of containing additives is n, an increase of the refractive indexes complies with a formula 1.
delta(%)=100×(n−n0)/n [Formula 1]

If the GeO2 is added, the refractive index is increased to the maximum amount of 3.5%, and if the P2O5 is added, the refractive index is increased to the maximum amount of 1.2%.

Also, if the transparent insulating film (13) is formed in many layers, more planarize surfaces of each layer by using a method like a CMP(Chemical Mechanical Polishing) process when necessary after depositing each transparent insulating film layer. Accordingly, it can more stably process a subsequent semiconductor process.

A fourth step (ST 130): on a lower substrate consisting of a transparent substrate (10) and the transparent insulating film (13), sequentially deposit and pattern a transparent insulating film (13) and an opaque conductive layer along a location where a micro lens array is formed, form thin film transistors, storage capacitors, and light transmission regions, and form pixel electrodes in upper parts of the light transmission regions. Connect the thin film transistors with the storage capacitors in parallel, and connect drain electrodes with pixel electrodes of the thin film transistors, so that signals passing through the thin film transistors can reach the pixel electrodes.

Then, refract light irradiated to the thin film transistors and the storage capacitors in the light transmission regions by micro lenses forming a micro lens array.

A fifth step (ST 140): an upper substrate on which opposite electrodes opposite to pixel electrodes of a lower substrate are deposited, is adhered to the lower substrate to maintain certain cell gaps, and then inject liquid crystals.

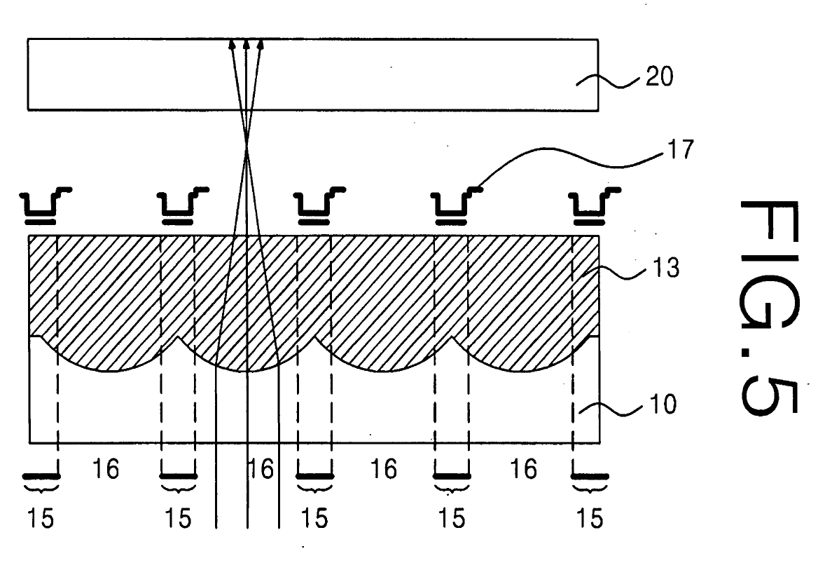

Like shown in FIG. 5, a light source of a liquid crystal display is incident on the lower substrate, and light is projected onto the upper substrate. Thus, images are displayed on a screen. FIG. 5 illustrates a liquid crystal panel created according to the present invention, showing that a micro lens array is formed by laminating a transparent insulating film (13) on a lower substrate (10). Thin film transistors (17) and pixel electrodes(not shown) are formed in an upper part of the transparent insulating film (13) to drive liquid crystals, and liquid crystal alignment layers(not shown) are formed thereon. Since incident light cannot be transmitted in regions formed by the thin film transistors (17), the regions become light cut-off regions (15) and other regions are formed as light transmission regions (16). Like shown in FIG. 5, centers of micro lenses formed on the lower substrate (10) are located in the light transmission regions (16).

Therefore, since the micro lens array is attached to the lower substrate, light irradiated in the light cut-off regions (15) of the liquid crystal display by the micro lens array is refracted in the light transmission regions (16). The light refracted in the light transmission regions (16) is passed or cut off by changing molecular arrangement of the liquid crystals according to voltages applied to the pixel electrodes, thereby forming images. And, the light is projected on a screen after passing through the upper substrate (20), then the images are displayed on the screen.

Moreover, if the transparent substrate is applied with an isotropic etching by controlling etching conditions in the above process, the transparent substrate is etched in vertical direction, performing a side etching process. Thus, the upper part of the transparent substrate is etched to have a concave type. On the contrary, if the etching process has a directional property, that is, if the etching process is performed in vertical direction, the transparent substrate is etched along shapes of photo registers, having a convex type. If the upper part of the transparent substrate is etched in concave state, the lower substrate can be completed, being attached with the concave-shaped micro lens array, by depositing an insulating film in the upper part and planarizing an upper part of the insulating film. If the upper part of the transparent substrate is etched in convex state, the lower substrate can be completed, being attached with the convex-shaped micro lens array, by depositing an insulating film thereon and planarizing an upper part of the insulating film.

In case of the lower substrate to which the convex-shaped micro lens array is attached, it is desirable to locate the centers of the lenses in the light cut-off regions.

### INDUSTRIAL APPLICABILITY

According to a liquid crystal display panel to which a micro lens array is attached and a making process thereof, it can increase an opening ratio of a liquid crystal display by refracting light projected on light cut-off regions to pixel regions and attaching the micro lens array.

In addition, after forming the micro lens array in the lower substrate, determine positions of the pixel regions to irradiate light in the pixel regions by refracting the light irradiated in the light cut-off regions according to density of the micro lens array and density of materials laminated in an upper part of the micro lens array. In this way, it is unnecessary to perform another micro lens array attaching process.

Accordingly, the present invention can simplify a process as well as remove a problem of reducing an effect of attaching the micro lens array due to inexact attachment of the micro lens array during the micro lens array attaching process. Also, there is no possibility of damaging the micro lens array, thereby reducing manufacturing cost with little material loss.

This invention may, however, be embodied in different forms and should not be construed as limited to the embodiments set forth herein. Rather, these embodiments are provided so that this disclosure will be thorough and complete, and will fully convey the scope of the invention to those skilled art.

1. A thin film transistor liquid crystal display panel, comprising:
liquid crystal material disposed between a transparent upper substrate and a transparent lower substrate, and a light cut-off unit having many thin film transistors for turning on/off the liquid crystals being formed on a surface of the lower substrate opposite the upper substrate,
wherein a plurality of micro lenses being formed by lens grooves and transparent insulating film on the lower substrate,
wherein said plurality of lens grooves being formed by etching on said surface of the lower substrate opposite to the upper substrate, and said lens grooves regularly being arranged and having predetermined radiuses, and;
wherein said transparent insulating film, said film having predetermined thickness, being disposed on the lens grooves and the lower substrate; and
wherein said thin film transistors being formed in an upper part of the transparent insulating film.

2. The thin film transistor liquid crystal display panel of claim 1, wherein the lens grooves are concave, and centers of the lenses are located in regions except said light cut-off regions.

3. The thin film transistor liquid crystal display panel of claim 1, wherein the lens groove are convex, and centers of the lenses are located in the light cut-off regions.

4. The thin film transistor liquid crystal display panel of claim 1, wherein the transparent insulating film is configured in a plurality of layers.

5. The thin film transistor liquid crystal display panel of claim 1, wherein the transparent insulating film is an oxide film to which impurities are added.

6. The thin film transistor liquid crystal display panel of claim 5, wherein the impurities are one of TiO2, GeO2, and P2O5.

7. The thin film transistor liquid crystal display panel of claim 1, wherein a light source irradiating light is disposed in a position where light is irradiated to the upper substrate from the lower substrate.

8. A method of making a thin film transistor liquid crystal display panel in which liquid crystal material is disposed between a transparent upper substrate and a transparent lower substrate, and a light cut-off unit being formed, said cut-off unit having many thin film transistors for turning on/off the liquid crystals on a surface of the lower substrate opposite to the upper substrate, said method comprising:
a first step of forming photoresist on a transparent substrate by depositing and patterning the photoresist on the transparent substrate;
a second step of etching the transparent substrate and creating certain size of lens grooves on the transparent substrate; and
a third step of forming the lower substrate by depositing a transparent insulating film in an upper part of the etched transparent substrate and planarizing an upper part of the transparent insulating film.

9. The method of claim 8, wherein at the third step, the transparent insulating film is formed in many layers.

10. The method of one of claim 8, wherein at the third step, the transparent insulating film is deposited by using a flame hydrolysis deposition method.

11. The method of claim 8, wherein in the third step, one of TiO2, GeO2, and P2O5 is added to the transparent insulating film.

12. The method of claim 8, wherein between the first step and the second step, a step of reflowing the photoresist is further comprised.

13. The method of claim 8, wherein after the third step, a process of planarizing the transparent insulating film by using a CMP process is further comprised.
